(19) United States
(12) Patent Application Publication
(10) Pub. No.: US 2023/0347334 A1
(43) Pub. Date: Nov. 2, 2023

(54) METHOD FOR ASSIGNING A PIPETTE TIP TO A PIPETTE TIP CLASS ON THE BASIS OF THE PNEUMATIC BEHAVIOUR THEREOF

(71) Applicant: Hamilton Bonaduz AG, Bonaduz (CH)

(72) Inventor: Jonas Hilti, Balzers (LI)

(21) Appl. No.: 17/799,514

(22) PCT Filed: Feb. 17, 2021
(86) PCT No.: PCT/EP2021/053921

§ 371 Date: Aug. 12, 2022

(30) Foreign Application Priority Data
Feb. 19, 2020 (DE) 10 2020 104 422.4

(51) Int. Cl. B01L 3/02

(52) U.S. Cl. CPC B01L 3/0275; B01L 3/0227; B01L 2200/146; B01L 2400/0487; B01L 2200/148

(57) ABSTRACT

A method for assigning a pipette tip to a certain class of pipette tips from a plurality of different pipette tip classes, the method including the following steps: coupling the pipette tip to a gas displacement device such that a device-side volume formed in the gas displacement device and a tip-side volume formed by the pipette tip communicate with each other, and thereby forming a measuring volume including the communicating volumes of the device-side volume and the tip-side volume; operating the gas displacement device and thereby changing the gas pressure in the measuring volume; detecting the gas pressure in the measuring volume over a detection time period; determining at least one absolute value of at least one characteristic variable characterizing the detected gas pressure; comparing the at least one determined absolute value with at least one predetermined calibration value; and, depending on the comparison result, assigning the pipette tip to a pipette tip class and outputting an item of class assignment information representing the assigned pipette tip class.

This application claims priority in PCT application PCT/EP2021/053921 filed on Feb. 17, 2021, which claims priority in German Patent Application DE 10 2020 104 422.4 filed on Feb. 19, 2020, which are incorporated by reference herein.

The present invention concerns a method for assigning a pipette tip to a particular class of pipette tips out of a plurality of different pipette tip classes. The present invention further concerns a pipetting device which is configured for implementing such a method.

### BACKGROUND OF THE INVENTION

From the state of the art there are known various methods for identifying pipette tips automatically, at least with regard to their size and/or their shape. This serves to prevent the use of a pipette tip which is incorrect for an imminent dosing task. For example, when using a pipette tip which is too small for a dosing task, during aspiration dosing fluid can, to begin with, completely fill an accommodating space of the pipette tip and during continued aspiration penetrate into a pipetting duct of a pipetting device and there contaminate the pipetting duct which in the air displacement pipetting method is actually only provided for the accommodation of working gas. Thus dosing fluid from previous pipetting processes can contaminate another dosing fluid which is to be in subsequent pipetting processes. Furthermore, dosing fluid penetrating into the pipetting duct can damage a pressure sensor which is provided there for acquiring the pressure of the working gas which actually during the dosing operation too, completely fills the pipetting duct. Even in the absence of contamination or damage, the coupling of a pipette tip which belongs to a different pipette tip class than the selected and expected pipette tip usually results in undesirable inaccuracies in the dosing itself.

The need to couple a correct pipette tip for a dosing process and avoid the coupling of pipette tips unsuitable for the dosing process is so obvious that no further explanations are required in this regard.

From WO 02/00345 A2 there is known a method for automated identification of pipette tips with regard to their belonging to a pipette tip class, which uses differently configured mating coupling sections at pipette tips in the assignment to different pipette tip classes. During the coupling of the pipette tips to a coupling section of a pipetting duct of a pipetting device, the mating coupling sections result in different relative movements of moveable device components of the pipetting device which are arranged in the region of a coupling section of the pipetting duct. From the different relative movement and/or the different relative position respectively of the device components during and/or after respectively of the coupling of a pipette tip, the known pipetting device recognizes whether a pipette tip of a desired pipette tip class or of a pipette tip class different from it has been coupled to its pipetting duct.

It is a drawback of this method that it presupposes pipette tips configured specifically for implementing the method, which bring with them through physical design at their mating coupling section which during coupling interacts with the coupling section of the pipetting device, the required information about belonging to a pipette tip class. Pipette tips different from this cannot be identified with this method.

From WO 2018/015422 A1 there is known an automated method for identifying pipette tips and/or for assigning pipette tips to pipette tip classes respectively, which works electrically-capacitively. Simply expressed, according to this method the pipette tip and/or a pipette tip holder carrying it is used as an electrode. By measuring the capacitance of the electrode thus formed, it is judged whether a pipette tip is even coupled to a pipetting duct, and if this is the case whether or not this is a desired pipette tip. The measured capacitance values are compared with stored predetermined reference values.

It is a drawback of this known method that due to the capacitance measurement carried out, it presupposes electrically conducting materials in the measurement region.

From U.S. Pat. No. 9,138,741 B2 there is known a method for automated identification of pipette tips in which the pipette tips, depending on their belonging to a pipette tip class, are provided with different markings which are read and evaluated by a sensor.

Like the method described above and known from WO 02/00345 A2, the method last named also assumes that the pipette tips used in the method are configured differently in accordance with their belonging to different pipette tip classes. A general applicability of this method to arbitrary pipette tips is thereby likewise ruled out, as with WO 02/00345 A2.

### SUMMARY OF THE INVENTION

Accordingly, it is the task of the present invention to propose a technical solution which makes it possible to ascertain the belonging of a pipette tip to a pipette tip class out of several different pipette tip classes as generally as possible and as independently as possible from the origin and the manufacturer of the pipette tips.

According to a first, process technical aspect, the present invention solves this task through a method which comprises the following steps:
Coupling the pipette tip to a gas displacement device in such a way that a device-side volume formed in the gas displacement device and a tip-side volume formed by the pipette tip communicate with one another, thereby forming a measurement volume comprising the communicating volumes: device-side volume and tip-side volume,
Operating the gas displacement device and thereby changing a gas pressure in the measurement volume,
Acquiring the gas pressure in the measurement volume over an entire acquisition period,
Ascertaining at least one quantitative value of at least one characteristic variable characterizing the acquired gas pressure,
Comparing the at least one ascertained quantitative value with at least one predetermined calibration value, and
Depending on the comparison result: Assigning the pipette tip to a pipette tip class and outputting a class assigning information which represents the assigned pipette tip class.

The pipette tip classes differentiable by the method can differ with regard to a nominal pipetting volume or nominal pipetting volume range assigned to the respective pipette tip classes and/or with regard to a shape or a shape range of the pipette tips assigned to the respective pipette tip classes. In this way the method can differentiate between pipette tips with different nominal pipetting volumes, where due to the different nominal pipetting volumes these pipette tips necessarily also differ with regard to their shape. The method can additionally or alternatively differentiate between pipette tips with the same nominal pipetting volume but with a different shape. Thus pipette tips with an identical nominal pipetting volume can, for example, be configured either with a greater axial dimension along a pipette tip axis and smaller radial dimension orthogonally to it or with a shorter axial dimension and instead greater radial dimension. In the first case there would be present a rather slim pipette tip, in the second case a rather stocky one.

Pipette tips within the meaning of the present application extend along a pipette tip axis between a mating coupling section with a mating coupling formation which is configured for coupling to a coupling formation of a coupling section of a pipetting duct, and a pipetting aperture through which dosing fluid is aspirated into an accommodating space formed between the mating coupling section and the pipetting aperture and dispensed out of it. Preferably, the pipetting aperture and an end-side aperture of the pipette tip at the mating coupling section are arranged coaxially with respect to the pipette tip axis, although this is not imperative. The aperture area of the end-side aperture at the mating coupling section, to be measured orthogonally to the pipette tip axis, is preferably many times greater, for instance by at least a factor of ten, preferably by at least a factor of twenty, than the aperture area of the pipetting aperture. Thereby, on the one hand the pipette tip can be securely coupled to a pipetting duct and held onto it, and on the other hand very small dosing volumes can also be aspirated into the accommodating space and dispensed from it.

The accommodating space determines the nominal pipetting volume of the pipette tip, where normally the total volume of the accommodating space is greater than the nominal pipetting volume in order to be certain during proper operation that dosing fluid reaches only the accommodating space and not also the pipetting duct of the pipetting device to which the pipette tip is coupled.

In order to achieve high standards of laboratory hygiene, preferably the pipette tip is configured as a single-use component and is disposed of after one use. Therefore, normally the pipette tip is produced cost-effectively as an injection-molded component.

Since normally the cross-sectional area of the pipetting aperture of a pipette tip coupled to a pipetting duct is smaller, even significantly smaller than the smallest cross-sectional area of the pipetting duct, working gas of the pipetting device displaced out of the pipetting duct into the accommodating space of the pipette tip cannot escape through the pipetting aperture out of the accommodating space as quickly as it is displaced out of the pipetting duct into the accommodating space. The compressible working gas is therefore compressed in the measurement volume, such that its pressure increases. For the same reasons, during opposite displacement i.e. during displacement of working gas out of the accommodating space into the pipetting duct, the compressible working gas expands into the measurement volume since gas is able to flow in from the environment through the smaller pipetting aperture less quickly than it is displaced by the gas displacement device from the accommodating space into the pipetting duct.

Depending on the shape and/or size of the coupled pipette tip, the pressure in the measurement volume changes differently over time for pipette tips which belong to different pipette tip classes. Therefore, from the pressure change in the measurement volume induced by the operation of the gas displacement device it is possible to draw conclusions about the pipette tip class to which the coupled pipette tip belongs.

By ascertaining at least one quantitative value of at least one characteristic variable each for different known pipette tips, for one thing pipette tip classes can be defined and for another, the calibration values with which the at least one quantitative value of the at least one characteristic variable are compared according to the method can be predetermined in the laboratory. In this way a library of calibration values can be created which are each assigned to pipette tip classes. Such calibration values can also and in particular be threshold values which divide two pipette tip classes from one another. By comparing the at least one ascertained quantitative value with the calibration values of the library, the pipette tip from which the at least one quantitative value of the at least one characteristic variable has been obtained can in this way, depending on the comparison result, be assigned to a pipette tip class.

In principle, in this process it can suffice to compare the at least one quantitative value only with exactly one predetermined calibration value in order to establish whether the investigated pipette tip belongs to a desired pipette tip class or not, i.e. for instance whether it exhibits a desired nominal pipetting volume and/or a desired shape or not.

Here it makes sense to compare each time only quantitative values and calibration values of the same entity with one another, i.e. quantitative values and calibration values which are of the same physical nature.

In the example quoted above of calibration values predetermined in the laboratory, the comparison between quantitative value and calibration value can be an examination whether the at least one quantitative value of the at least one characteristic variable agrees sufficiently accurately with at least one predetermined calibration value. Sufficiently accurate agreement can exist here if the quantitative value deviates from the calibration value used for comparison by less than a predetermined difference. If such a sufficiently accurate agreement is established, the pipette tip is assigned to the pipette tip class to which the sufficiently agreeing calibration value is also assigned. This assigning can be output as a class assigning information.

In order to increase the informative value of the class assigning information, the comparison can comprise a further examination whether the at least one quantitative value of the at least one characteristic variable agrees sufficiently accurately only with the at least one calibration value of exactly one pipette tip class. According to this advantageous further development, it can be provided that a class assigning information is only output when the sufficiently accurate agreement exists only with the at least one calibration value of exactly one pipette tip class, such that the comparison result is unambiguous.

For the rather unlikely case that the at least one quantitative value of the at least one characteristic variable agrees sufficiently accurately with the at least one calibration value of several pipette tip classes, there can be assigned to the investigated pipette tip that pipette tip class, and through the output of a class assigning information be indicated as assigned, whose at least one calibration value exhibits the greatest agreement with the at least one quantitative value of the at least one characteristic variable, thus for example whose at least one calibration value deviates from the at least one quantitative value of the at least one characteristic variable by the quantitatively least difference.

In the case of the aforementioned difference, it is all the same or more specifically equivalent whether the calibration value deviates from the quantitative value or vice versa.

In the last-mentioned case of several sufficiently accurate agreements, several pipette tip classes can also be assigned to the investigated pipette tip and a corresponding class assigning information output. The class assigning information then preferably comprises a quality information which specifies which pipette tip class exhibits the best agreement and which pipette tip class the least but still sufficient agreement. Such a quality information can, for example, consist of the output of a sequence of the assigned pipette tip classes.

When the at least one calibration value is a threshold value which divides two pipette tip classes from one another, through a comparison of the at least one ascertained quantitative value with the at least one calibration value there can be assigned to the pipette tip that pipette tip class which is assigned to a range of values above a lower limit calibration value and/or below an upper limit calibration value. This assigning of the pipette tip can then be output as a class assigning information.

In principle, the gas displacement device can be an arbitrary such device, for instance a rotary displacement pump with a rotating displacement component. Preferably, however, the method is implemented in a pipetting device, which is why the operating of the gas displacement device preferably comprises a displacement of a piston in a cylinder along a cylinder axis.

In principle, for ascertaining the desired assigning it can suffice if the operating of the gas displacement device comprises a displacement of the piston only in one direction in the cylinder, where this direction preferably, but not imperatively, is a displacement direction which effects a pressure increase in the measurement volume. A greater quantity of data, and thereby the possibility of more reliable assigning, can be obtained by the operation of the gas displacement device comprising a displacement of a piston in a first direction and subsequently a direction opposite the first direction. Then the gas pressure in the measurement volume can be acquired during each piston movement of the two opposite piston movements, such that in principle the double amount of quantitative values of at least one characteristic variable can be ascertained than if the operation of the gas displacement device comprised a displacement of the piston in only one direction.

When the operation of the gas displacement device comprises a displacement of a piston in two opposite directions, preferably the end position of the piston at the end of the operation is its starting position before the beginning of the operation. Thus a state of preparedness of a pipetting device is not changed by the assigning method, which normally is followed by a pipetting operation.

In principle, there are available various observable gas pressure-changing processes in the measurement volume for assigning a pipette tip being investigated to a pipette tip class. According to a first embodiment of the method, the ascertaining of the at least one quantitative value can be based on gas pressure values which are or were acquired during the operation of the gas displacement device, where the operation effects the acquired gas pressure values. Thus, here the gas pressure is acquired while the gas displacement device displaces gas in the measurement volume. The advantage of this methods lies in its relatively long duration, which can last one or preferably even 2 seconds or more than 2 seconds, such that a large set of quantitative values of the acquired gas pressure can be ascertained. This in turn makes possible highly reliable assigning. Because of the operating duration of the gas displacement device of 1 second or more, this first embodiment is a slow or more specifically slower embodiment compared with the second embodiment explained below.

According to an especially preferred first embodiment of the method, the operation of the gas displacement device therefore comprises a displacement of the piston at a constant piston velocity for a constant displacement duration. Furthermore, the acquisition of a gas pressure in the measurement volume takes place during the constant displacement duration. Likewise, the ascertaining of at least one quantitative value is based on gas pressure values acquired during the constant displacement duration.

When the operation of the gas displacement device comprises a displacement of a piston in two opposite directions, preferably each of the two displacements taking place in opposite directions comprises a displacement of the piston at a constant piston velocity for a constant displacement duration.

During the constant displacement duration, despite the displacement of gas between the device-side volume and the tip-side volume of the measurement volume, there prevail in the measurement volume quasi-stationary conditions which last at least for the duration of at least one, preferably several, such as for instance four or five tenths of a second, such that in these phases the possibility exists of comparing with one another quantitative values ascertained during one and the same constant displacement duration, and thus to draw conclusions about the correct process of the gas pressure acquisition and about correct functioning of a gas pressure sensor. Preferably in this embodiment the method can comprise an output of an information which represents the proper or improper functioning of a gas pressure sensor involved in the method.

Such a method in accordance with the aforementioned preferred first embodiment is first and foremost applicable with high informative value and without problems to such pipette tip whose accommodating space is filled only with gas in an initial state free from dosing fluid before first use.

There also exist, however, as for example the aforementioned U.S. Pat. No. 9,138,741 B2 shows, such pipette tips in whose accommodating space a filter, normally gas-permeable, is arranged which can have an assigning-result falsifying effect on a change in the gas pressure in the slow embodiment described above of the present method.

In particular for assigning such filter-equipped pipette tips to a pipette tip class, a second embodiment of the method can be used according to which the ascertaining of at least one quantitative value is based on gas pressure values which are or were acquired over time after the operation of the gas displacement device, which effects the acquired gas pressure values. It should be pointed out, however, that this second embodiment of the method is applicable to every kind of pipette tip, including to such filter-free pipette tips whose accommodating space is filled before first use solely with gas.

In the case of the second embodiment, the acquisition of the gas pressure normally takes place after the operation of the gas displacement device because the gas displacement device is operated in a gas-displacing manner only over a very short period of for example less than 0.1 seconds, preferably even less than 0.04 seconds, and in the measurement volume the temporal change in the gas pressure is observed as a response to the operation of the gas displacement device. Therefore, the second embodiment of the method is the quick or more specifically the quicker embodiment compared with the first embodiment described above.

Whereas the first embodiment of the method focuses predominantly on the acquisition of a gas pressure in the measurement volume which is determined by mass balancing processes based on a gas pressure difference between the gas pressure in the measurement volume and the surrounding atmospheric pressure effected by the operation of the gas displacement device, the second embodiment of the method focuses predominantly on the acquisition of a gas pressure in the measurement volume which is determined by at least one pressure pulse effected by the operation of the gas displacement device and where applicable its attenuation through internal friction in the gas present in the measurement volume without appreciable mass balancing processes through the pipetting aperture.

Therefore, according to the preferred second embodiment, the operation of the gas displacement device which effects the acquired gas pressure values comprises the production of a gas pressure surge in the measurement volume. Due to the gas pressure surge or more specifically the gas pressure pulse, gas present in the measurement volume is excited at least section-wise to oscillate, such that from the excited oscillation form there can be obtained at least one quantitative value of at least one characteristic variable characterizing the oscillation form. For example, the at least one quantitative value can comprise at least one frequency and/or at least one amplitude and/or at least one decay factor. A decay factor is understood here as a variable which describes the quantitative change in amplitudes of consecutive local extreme values of an excited gas pressure oscillation. It is possible to use only positive amplitudes or only negative amplitudes or consecutive positive and negative amplitudes for characterizing the oscillation form as a characteristic variable.

According to a preferred embodiment, the production of a gas pressure surge in the measurement volume comprises a piston movement in two opposite directions in the cylinder each with a stroke size per direction of at least 0.5 mm with a total movement duration of no more than 12 ms, preferably of no more than 8 ms, especially preferably of no more than 6 ms.

For example, experiments have shown that an abrupt piston movement with identical stroke sizes in both opposite directions, i.e. where at the end the piston return to its starting position, is especially advantageous for the excitation of an oscillation in the gas of the measurement volume. For example, a piston movement in two opposite directions each with a stroke of between 0.9 to 1.1 mm, preferably of exactly 1 mm within 3 to 6 ms in total, preferably between 3.8 and 4.2 ms in total, especially preferably of 4 ms has shown outstanding results in the excitation of characteristic oscillation forms which are distinct for different pipette tip classes. For this preferred parameterized configuration too, preferably the stroke size is the same in both opposite movement directions.

The acquisition duration after a pulse-like oscillation excitation, as described above, should be at least so long that the excited oscillation is recognizable in the change of the gas pressure values over time. Preferably, therefore, the acquisition duration comprises at least the time interval from the beginning of a gas pressure change effected by the operation of the gas displacement device until the first return of the gas pressure to its initial value at the beginning of the gas pressure change. Thereby the excited oscillation can be observed at least over a half-period, where the half-period by itself can already be a characteristic variable characterizing the oscillation form.

The assigning of the pipette tip to a pipette tip class becomes more reliable when the excited oscillation is observed over a longer time scale, which is why the acquisition duration comprises at least double, preferably at least triple the time interval from the beginning of a gas pressure change effected by the operation of the gas displacement device until the first return of the gas pressure to its initial value at the beginning of the gas pressure change.

Normally the excited oscillation as described above has decayed so far after the fourth to fifth multiple of the first half-period, that its further observation through sensor-based acquisition of the gas pressure no longer provides an appreciable informational contribution. In order to avoid excessively long assigning methods and not impair unnecessarily the productivity of a pipetting device implementing the method, the acquisition duration preferably comprises no more than the tenth multiple, preferably no more than the sixth multiple, of the time interval from the beginning of a gas pressure change effected by the operation of the gas displacement device until the first return of the gas pressure to its initial value at the beginning of the gas pressure change.

In the first or slow embodiment described above of the method presented here, the characteristic variable can be a mean of the acquired gas pressure. Preferably the characteristic variable is a mean value of the gas pressure values acquired during the aforementioned constant displacement duration. To wit, experiments have shown that during the constant displacement duration—regardless of the direction of the piston's movement—an essentially constant gas pressure prevails in the measurement volume. This can be attributed to a static equilibrium which sets in during a constant piston movement at a constant piston velocity between the volume traversed per unit time by the displacing piston surface and the gas flow per unit time entering or exiting through the pipetting aperture. The mean value of this gas pressure which is essentially constant over a certain length of time can be ascertained especially accurately. Moreover, it differs in a way that carries informative value for different nominal pipetting volumes and even for different shapes of pipette tips with the same nominal pipetting volume.

As already elucidated above in connection with the observation of excited oscillation forms, for the second or rapid embodiment of the present method the characteristic variable can comprise at least one variable which characterizes a temporally transient course of the acquired gas pressure. Such a variable which characterizes a temporally transient course can comprise at least one frequency and/or at least one amplitude and/or one course of amplitudes over time and/or one period and/or a course of the periods over time and the like. Such a characterizing variable can besides be at least one parameter of a function which approximates the transient course of the acquired gas pressure. This assumes that when predetermining the calibration values, the gas in the measurement volumes formed by known coupled pipette tips is excited in a pressure pulse-like manner in the same way as later in investigated pipette tips by an operation of the gas displacement device and the thus observable transient course of the gas pressure is approximated by the same approximation function with quantification of the same function parameters of this approximation function.

For example, a pipette tip coupled to a pipetting duct can form together with the pipetting duct a Helmholtz resonator whose pressure oscillation behavior in dependence on the piston position can be stated as a function of time by always the same basic form of a differential equation. The parameterization of this differential equation, that is, the quantification of the originally unknown coefficients of the differential equations, starting from the observed oscillation form leads on the one hand to a set of calibration values which can be assigned to a pipette tip class, and on the other when implementing the method to a set of quantitative values of at least one characteristic variable.

According to a second, device-related aspect, the present invention concerns a pipetting device, comprising a pipetting duct with a coupling formation which is configured for detachable coupling of a pipette tip, where the pipetting device comprises:
A pipetting duct filled with working gas, which penetrates through the coupling formation,
A gas displacement device which is in a hydromechanically communicating operative connection with the pipetting duct and is configured to displace working gas in the pipetting duct,
A pressure sensor which is arranged and configured to acquire and output a pressure of the working gas,
A control device for controlling the operation of the gas displacement device and of the pressure sensor,
A data storage device, comprising at least one storage medium, for the storage of data output by the pressure sensor which represent at least one pressure value of the working gas, where in the data storage device there are stored data which represent at least one calibration value, preferably a plurality of calibration values, for a comparison with at least one quantitative value of at least one characteristic variable characterizing the acquired working gas pressure,

Where the pipetting device is configured for implementing the method, as is described and further developed above.

Configurations and further developments of the pipetting device arising from the above method description are further developments of the aforementioned pipetting device and vice versa. The working gas mentioned in connection with the description of the pipetting device, preferably air, is the gas mentioned above in connection with the description of the method and vice verse.

Accordingly, the gas displacement device preferably comprises a pipetting piston and a cylinder, where the pipetting piston is accommodated in a displaceable manner in the cylinder along a cylinder axis which defines an axial direction and a radial direction orthogonal to the latter as a working gas displacement component. A part of a cylindrical cavity of the cylinder which in respect of the pipetting piston is situated on the side of the coupling formation of the pipetting duct contributes to the formation of the pipetting duct, and in the event of a coupled pipette tip to the formation of the measurement volume. The pipetting piston of the pipetting device is the piston mentioned above in the description of the method.

In order to be able to produce in a defined and repeatable manner the pressure pulses required for the second embodiment described above of the method as advantageously “hard” pulses with the stated short duration, the pipetting piston preferably exhibits at least one permanent magnet and the pipetting device exhibits current-carrying conductor coils at least in an axial drive section radially outside the pipetting duct. Thereby, a linear motor can be formed out of conductor coils and pipetting piston, whose rotor is the pipetting piston itself. This pipetting piston which is driven linear-motorically by the conductor coils as a stator, is moveable at very high accelerations and very high peak velocities even in only very short operating periods. Preferably the control device is configured for energizing the conductor coils with current, in order to control the movement of the piston with high accuracy.

In order to avoid an unnecessarily high number of components in forming the pipetting device, preferably the control device of the pipetting device which in any case is configured to perform control and data processing tasks is configured not only at least to control a movement of the pipetting piston and the operation of the pressure sensor, but also to perform the aforementioned method steps: Ascertaining and comparing values and also, depending on the comparison result, assigning a pipette tip assigned to the ascertained quantitative values to one out of at least two pipette tip classes. To this end the control device preferably exhibits at least one integrated circuit. The control device is furthermore configured for reading data from and for writing data into the data storage.

For outputting the class assigning information, the pipetting device can exhibit an output device, for instance a screen and/or a loudspeaker and/or a preconfigured display device, which is controllable by the control device.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1A rough schematic longitudinal section through a pipetting device according to the invention with an unused pipette tip coupled thereon,

FIG. 2 in the upper image half a diagram which shows the relative position of the pipetting piston relative to its initial position during an implementation of a first embodiment of the method according to the invention as a function of time, and in the lower image half a diagram which shows the working gas pressure in the measurement volume as a function of time during the implementation of the first embodiment of the method according to the invention,

FIG. 3A diagram which shows pressure fluctuations in the measurement volume of the pipetting device of FIG. 1 as a function of time for a second embodiment of the method according to the invention, and

FIG. 4A diagram which shows pressure fluctuations in the measurement volume of a pipetting device modified compared to that of FIG. 1 as a function of time according to a second embodiment of the method according to the invention.

### DESCRIPTION OF PREFERRED EMBODIMENTS

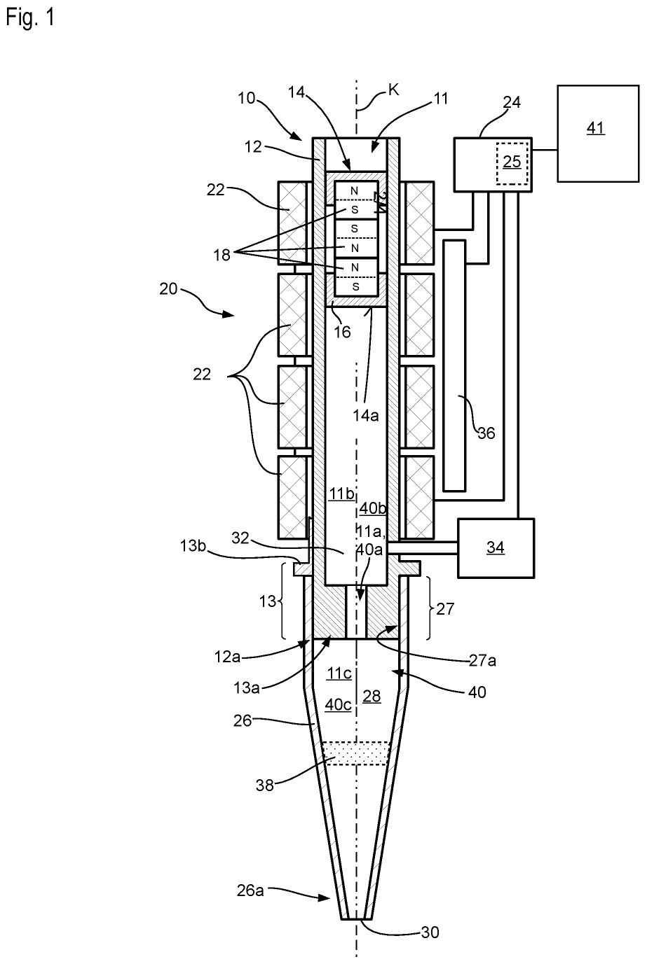

Referring now to the drawings wherein the showings are for the purpose of illustrating preferred and alternative embodiments of the invention only and not for the purpose of limiting the same, in FIG. 1, a pipetting device according to the invention is labelled generally as 10. It comprises a pipetting duct 11, comprising a cylinder 12 which extends along a duct path K configured advantageously as a straight duct axis. The duct path K is also the cylinder axis of the cylinder 12. In this pipetting duct 11 there is accommodated moveably a pipetting piston or also in brief piston 14 along the duct path K.

The piston 14 comprises two end caps 16 (for the sake of clarity, in FIG. 1 only the lower one is provided with a reference label), between which there are accommodated a plurality of permanent magnets 18 (in the present example, three permanent magnets 18). In order to achieve a magnetic field which is sharply separated along the duct path K, the permanent magnets 18 are polarized and arranged pairwise along the duct axis K with similar poles facing towards one another. From this arrangement there results a magnetic field proceeding from the piston 14, which to the largest extend is uniform about the duct axis K, i.e. essentially rotation-symmetrical with respect to the duct axis K is and which exhibits along the duct axis K a high gradient of magnetic field strength, such that opposite polarization zones alternate in a sharply separated manner along the duct path K. Thereby, for example through Hall sensors of a position sensor arrangement 36, a high positional resolution can be achieved in the position acquisition of the piston 14 along the duct axis K, and very efficient coupling of an external magnetic field to the piston 14 can be achieved.

The end caps 16 are preferably formed of low-friction material comprising graphite or mica, as is known for example from commercially available caps supplied by Airpot Corporation of Norwalk, Connecticut (US). In order to be able to exploit as fully as possible the low friction offered by this material, the pipetting duct 11 preferably comprises a cylinder 12 made of glass such that during a movement of the piston 14 along the duct axis K, the graphite- or mica-comprising material slides with extremely low friction along a glass surface.

The piston 14 thus forms a rotor of a linear motor 20, whose stator is formed by the coils 22 surrounding the pipetting duct 11 (here by way of example there are depicted only four coils).

Let it be pointed out expressly that FIG. 1 is merely a rough schematic longitudinal section representation of a pipetting device 10 according to the invention, which on no account should be understood as being to scale. Moreover, pluralities of components are depicted by an arbitrary number of components, such as for instance three permanent magnets 18 and four coils 22. In point of fact, both the number of permanent magnets 18 and the number of the coils 22 can be greater or indeed smaller than the depicted number.

The linear motor 20, more precisely its coils 22, are actuated via a control device 24 which is connected with the coils 22 for signal transmission. The transmission of electric current for energizing the coils and thereby for producing a magnetic field through them also counts as a signal. In the control device 24 there is integrated a data storage device 25, in which the operating system of the pipetting device 10 is stored and in which sensor data from sensors connected with the control device 24 for signal transmission, such as for instance the position sensor arrangement 36 or also a pressure sensor 34 explained further below, can be stored.

At the dosing-side end 12a of the cylinder 12 there is coupled detachably in a way which is known per se a pipette tip 26. The connection of the pipette tip 26 with the dosing-side longitudinal end 12a of the cylinder 12 is likewise depicted merely in a rough schematic manner. The dosing-side longitudinal end 12a of the cylinder 12 is configured for detachable coupling of the pipette tip 26 as a coupling section 13 with a coupling formation 13a. Likewise, the end section of the pipette tip 26 which during pipetting operation is located nearer to the pipetting duct 11 is configured as a mating coupling section 27 with a mating coupling formation 27a. In the operational coupled state, the coupling section 13 of the pipetting duct 11 or more specifically of the cylinder 12 and the mating coupling section 27 of the pipette tip 26 overlap axially. The coupling formation 13a and the mating coupling formation 27a are in frictional and/or positive locking engagement, which holds the pipette tip 26 at the cylinder 12.

As part of the coupling section 13, there can for example be provided a stripping-off component 13b at the pipetting device 10, which is moveable along the duct path K in order to strip off a coupled pipette tip 26 from the coupling section 13. The operation of the stripping-off component 13b can also be controlled by the control device 24.

The pipette tip 26 defines a pipetting space or more specifically accommodating space 28 in its interior, which is accessible at the coupling-remote longitudinal end 26a solely through a pipetting aperture 30. The pipette tip 26, during its coupling to the cylinder 12, extends the pipetting duct 11 up to the pipetting aperture 30.

In the example depicted in FIG. 1 of the pipetting device 10, there is no dosing fluid accommodated in the pipetting space 28 and hence in the pipetting device 10. The pipette tip 26 is in an unused state.

Between the piston 14 and the pipetting aperture 30 there is situated only working gas 32, which serves to transmit force between the piston 14 and a dosing fluid.

According to an alternative indicate in FIG. 1 merely by a dotted line, the pipette tip 26 can carry a filter device 38 in its accommodating space 28. The filter device is usually gas-permeable in order to allow the effect of the working gas 32 at the pipetting aperture also, but is impermeable to fluids in order to prevent aspirated dosing fluid reaching the coupling formation 13a.

A pressure sensor 34 can acquire the pressure inside the pipetting duct 11, to which also the accommodating space 28 which is connected in a pressure-communicating manner belongs, the pressure of the working gas 32 between the pipetting aperture 30 or an aspirated dosing fluid and the dosing-side end face 14a of the piston 14, and transmit it via a signal line to the control device 24. The pressure sensor 34 or more specifically pressure signals supplied by it, which represent the pressure of the working gas 32, can be used to control the pipetting device 10 in the conventional quasi-synchronous pipetting operation both for aspirating and for dispensing dosing fluid.

The position sensor arrangement 36 for acquiring the piston's position is provided at the pipetting duct 11 and connected for signal transmission with the control device 24.

In the coupled state, a filter-free pipette tip 26 and the cylinder 12 form a contiguous measurement volume 40 in the region between the pipetting aperture-side piston surface 14a and the pipetting aperture 30. When the pipette tip 26 exhibits a filter 38, the contiguous measurement volume 40 extends between the pipetting aperture-side piston surface 14a and the filter 38.

In the region of the coupling formation 13a there is configured at the pipetting duct 11a constriction, i.e. in the region of the coupling formation 13a the duct cross-section of the pipetting duct 11 is smaller than on both sides of the coupling formation 13a. The smaller duct cross-section of the pipetting duct section 11a in the region of the coupling formation 13a is, however, still greater than the aperture cross-section of the pipetting aperture 30.

In the case of a pressure surge in the working gas 32 induced by a rapid movement of the piston 14 along the duct path K, the working gas component in the pipetting duct section 11a or more specifically in the measurement part-volume 40a contained therein in the coupling formation 13a with a narrower duct cross-section acts as a mass, whereas the working gas components in the pipetting duct section 11b situated above it in the cylinder 12 with a larger duct cross-section or more specifically in the measurement part-volume 40b contained therein and in the pipetting duct section 11c situated below it in the pipette tip 26 with a likewise larger duct cross-section or more specifically in the measurement part-volume 40c contained therein, each acts as a gas spring.

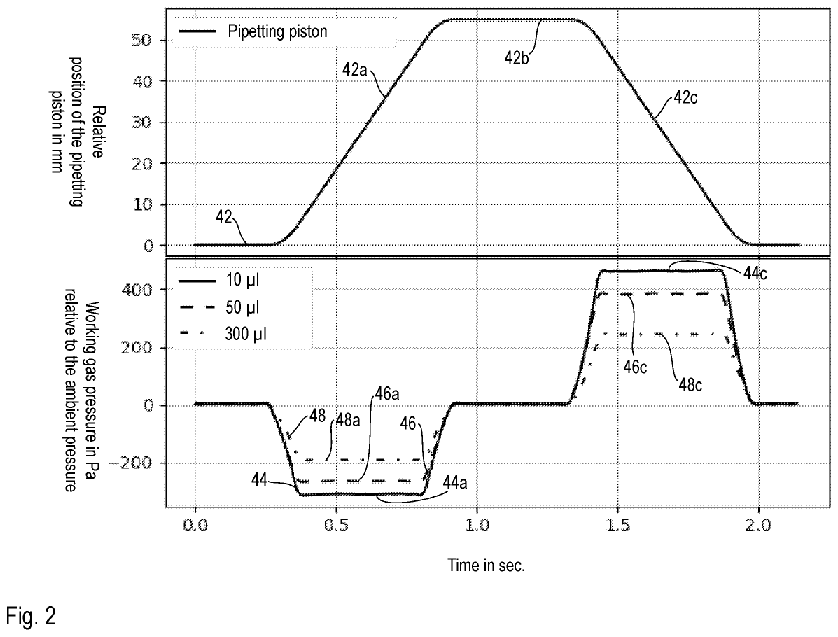

In FIG. 2, top, there is recorded a movement of the pipetting piston 14 during a first, slower embodiment of the method according to the invention. This method is applicable with filter-free pipette tips 26, that is, with pipette tips 26 whose accommodating space 28 is filled solely with working gas 32.

At the position “0” in the upper diagram of FIG. 2, the piston 14 is situated at its starting position located next to the coupling formation 13a and is then moved in the direction of increasing positive coordinate values away from the coupling formation 13a.

The graph 42 of the piston movement of FIG. 2 exhibits in the interval of approximately 0.35 to 0.82 seconds a phase 42a of moving away from the coupling formation 13a at a constant velocity, as can be seen from the straight line in the position-time diagram 42 of the pipetting piston 14 in the top half of FIG. 2.

The phase 42a at a constant non-zero velocity, is followed by a phase 42b in which the piston 14 is stationary at a distance of approximately 56 mm from its starting point for a little less than half a second. Subsequently the pipetting piston 14 is moved back to it starting position at 0 mm, where during this movement the piston exhibits a constant velocity in the interval from approximately 1.42 sec to approximately 1.89 seconds. This phase of the return movement of the pipetting piston 14 to the starting point at a constant velocity is labelled here 42c.

Since, as already mentioned earlier, the cross-sectional area of the pipetting aperture 30 is considerably smaller than the smallest cross-sectional area of the pipetting duct in the pipetting duct section 11a, gas flows from the environment through the pipetting aperture more slowly than the piston 14 enlarges the measurement volume 40 by its movement. The same applies to the return movement of the piston 14: working gas flows through the pipetting aperture 30 more slowly out of the accommodating space 28 than the piston 14 reduces the enlarged measurement volume 40.

Thereby during the enlargement of the measurement volume 40 in the phase 42a, there is underpressure in the measurement volume 40 and during the decrease of the measurement volume during the phase 42c there is overpressure in the measurement volume 40, after the plateau phase 40b during which the piston 14 is stationary and the pressure of the working gas 32 in the measurement volume 40 equalizes with the ambient pressure of the external environment outside the pipette tip 26.

In the bottom half of FIG. 2 there are recorded courses of relative pressures of the working gas 32 against time in the measurement volume 40 relative to the ambient pressure of the external environment outside the pipette tip 26. The solid line of the pressure course 44 indicates a pipette tip with a nominal pipetting volume of 10 μl, the dashed line of the pressure course 46 a pipette tip with a nominal pipetting volume of 50 μl, and the dotted-dashed line of the pressure course 48 a pipette tip with a nominal pipetting volume of 300 μl. Since for a given movement of the piston 14, the measurement volume changes least, in percentage terms, relative to the nominal pipetting volume in the case of the largest pipette tip, it is understandable that the pressure changes effected by a given piston movement decrease with increasing nominal pipetting volume.

The pressure courses in the bottom half of FIG. 2 are not representations of the raw pressure acquisition data of sensor 34, but rather data smoothed by a filter, for instance a lowpass filter. The smoothing of the data can effect a minor shift of the curves 44, 46, and 48 in FIG. 2 to the left, i.e. towards earlier times, but this does not matter in the first embodiment of the method according to the invention.

Due to the phases 42a and 42c of the piston movement at a constant non-zero velocity, there take place in the coupled pipette tips phases of constant underpressure or constant overpressure respectively of the working gas 32 in the pipetting duct 11 or more specifically in the measurement volume 40 relative to the ambient pressure. Phases of constant underpressure which were effected through the movement phase 42a of an increase in the measurement volume 40 through movement of the pipetting piston 14 away from its starting position at a constant velocity, are likewise labelled “a” in the bottom half of FIG. 2. Analogously, phases of constant overpressure which were effected through the movement phase 42c of the pipetting piston 14 are labelled “c”.

The mean pressure values ascertainable during the phases 44a, 46a, and 48a and/or during the phases 44c, 46c, and 48c, in which the value of the pressure of the working gas 32 in the measurement volume 40 is in any case essentially constant, are a reliable indicator of the coupled pipette tip 26. Given the same shape and/or the same nominal pipetting volume of coupled pipette tips 26, and with always the same movement profile of the pipetting piston 14 in the measurement volume 40 in the phases with essentially constant relative underpressure and essentially constant relative overpressure of the working gas 32 relative to the ambient pressure, there always set in essentially the same mean pressure values. These can be ascertained in a laboratory under a calibration operation and stored in the data storage 25 for a comparison with the pressure values ascertained during the implementation of the present method.

In order to take into consideration fabrication tolerances of the pipette tips 26, a class of pipette tips with an essentially identical nominal pipetting volume and/or essentially identical shape can have value ranges assigned to it extending from a lower limit to an upper limit, such that a spread of ascertained mean pressure values of pipette tips of one and the same pipette tip class always lies within an unambiguous range of values.

As is apparent from FIG. 2, the method in its first embodiment lasts at least 1 second to 1.5 seconds between the beginning of the movement of the piston 14 and the end of same after returning to the starting position. The return to the starting position is advantageous but not requisite to the method.

The piston 14 is actuated meanwhile by the control device 24 to move in accordance with the movement curve 42. The pressure of the working gas 32 is acquired during the piston movement. In this process, the phases 44a, 46a, and/or 48a and 44c, 46c, and/or 48c respectively of essentially constant working gas pressures are ascertained and the mean pressure values occurring during these phases ascertained. The mean pressure values are compared with predetermined calibration values, and depending on the comparison result the coupled pipette tip 26 is assigned to a predetermined pipette tip class.

The mean working gas pressure during phases of constant under- and/or overpressure is a characteristic variable within the meaning of the present application. The concrete values of the mean working pressure during these phases are the assigned quantitative values of this characteristic variable.

The first embodiment of the method according to the invention, elucidated in more detail in connection with FIG. 2, leads when using pipette tips 26 with a filter 38 built into the accommodating space 28 to results which do not carry informative value.

When the pipette tip 46 carries a filter 38, the second embodiment of the method presented here can be used. Needless to say, the second embodiment can also be used for filter-free pipette tips 26 in assigning them to a pipette tip class.

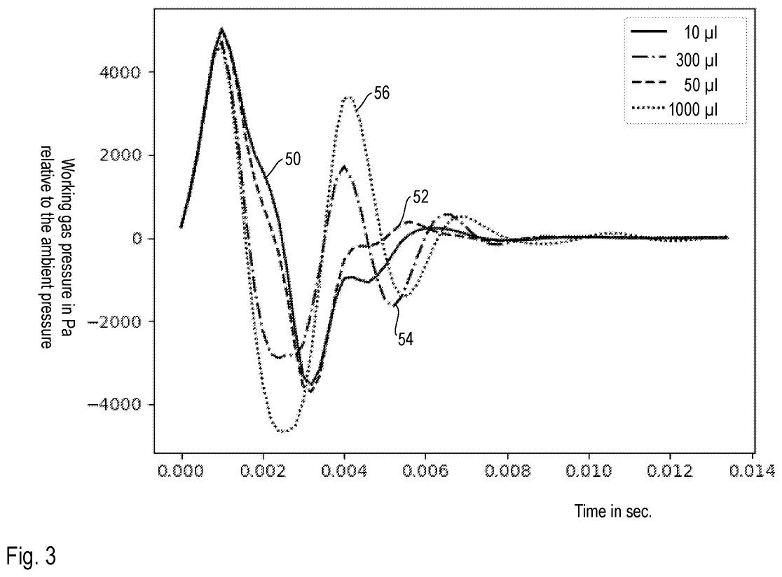

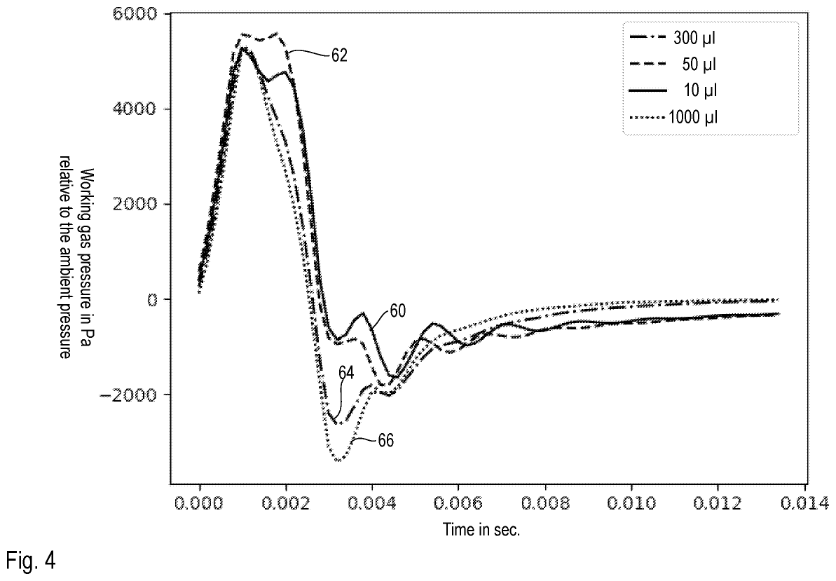

FIG. 3 depicts temporal pressure courses of differently sized pipette tips, obtained by means of a pressure pulse produced with the pipetting piston 14. Unlike the pressure curve of FIG. 2, lower half, effected by pressure and mass balancing in the measurement volume 40, the pressure courses of FIG. 3 and also of FIG. 4 are only observable as a response to a movement of the pipetting piston 14. The pipette tips used for ascertaining the values of FIG. 3 did not carry a filter.

In the present example, the pipetting piston 14 was moved for a predetermined stroke, approximately 1 mm, towards the coupling formation 13a and subsequently back away from the coupling formation 13a. The total movement of the pipetting piston 14 lasted no longer than 4 ms. Through this very quick movement of the pipetting piston 14 in a very short time, there was produced a pressure pulse which decays in the measurement volume 40 due to attenuation through internal friction in the working gas 32.

The pressure curve of a pipette tip with a nominal pipetting volume of 10 μl is once again shown in FIG. 3 by a solid line. The curve is labelled 50. The pressure curve of a pipette tip with a nominal pipetting volume of 50 μl is depicted in FIG. 3 by a dashed line and labelled 52. The pressure curve of a pipette tip with a nominal pipetting volume of 300 μl is depicted in FIG. 3 by a dotted-dashed line and labelled 54. The pressure curve of a pipette tip with a nominal pipetting volume of 1000 μl is depicted in FIG. 3 by a dotted line and labelled 56.

The pressure curves 50, 52, 54, and 56 of FIG. 3 differ from each other with regard to their oscillation forms. This is manifested through different amplitude values of consecutive oscillations or half-oscillations and/or different periods or half-periods. Since the period is the inverse of the frequency is, the same applies to the ascertainable frequencies.

Whereas the pipette tips with a nominal pipetting volume of 300 μl and of 1000 μl still complete the first half-oscillation and also the first full oscillation in approximately the same time, the pressure courses obtained with them differ considerably from one another as from the first negative amplitude, i.e. the second occurring amplitude of the acquired oscillation form.

As is further apparent from FIG. 3, the pressure courses of the pipette tips with a nominal pipetting volume of 300 μl and of 1000 μl also differ in terms of their period or frequency as from the third half-oscillation.

The pressure courses of pipette tips with a nominal pipetting volume of 10 μl and of 50 μl differ not only quite obviously in terms of period and amplitude from the previously considered corresponding values of the pipette tips with a nominal pipetting volume of 300 μl and of 1000 μl, they also differ among themselves. Whereas the amplitudes of the pressure courses of the pipette tips with a nominal pipetting volume of 10 μl and of 50 μl in the first and in the second half-oscillation are still approximately equal in magnitude, they differ quite considerably from one another as from the third half-oscillation. The periods of the pressure courses of the pipette tips with a nominal pipetting volume of 10 μl and of 50 μl are already different for the first half-oscillation, since the pressure course of the smaller pipette tip with a nominal pipetting volume of 10 μl returns measurably and significantly later to its initial value than the pressure course of the pipette tip with 50 μl nominal pipetting volume.

The characteristic variables to be used for differentiating the belonging of pipette tips to predetermined pipette tip classes can be ascertained during the production of calibration value files. In the present example of FIG. 3, for example the periods of the first half-oscillation and likewise the amplitude of the third half-oscillation are characteristic variables with informative value for differentiating the coupled pipette tips. This is mentioned only as an example. Alternatively or additionally, the period of the third half-oscillation could also be used as a characteristic variable.

Thus according to the second embodiment, the working gas 32 in the measurement volume 40 is excited into oscillating by means of a pressure surge through the quick movement of the piston 14 described above. The temporal course of the excited pressure oscillation is acquired, and is quantified based on predetermined characteristic variables by ascertaining their quantitative values. The quantitative values thus ascertained are compared with predetermined calibration values. Depending on the comparison result, the pipette tip 26 coupled during the pressure excitation and the acquisition of the pressure oscillations is assigned to a predetermined pipette tip class.

A pipette tip 26 with working gas 32 excited into oscillating in the measurement volume 40 can be regarded as a Helmholtz resonator, with the working gas column in the measurement part-volume 40a as an oscillating mass and with the working gas components in the measurement part-volumes 40b and 40c as air springs.

The behavior of a Helmholtz resonator, in the present case the pressure changes in the working gas 32 as a response to a movement of the piston 14, can always be modelled by a differential equation of the same structure. Such a differential equation can be written generally as follows:

aₙ·p⁽ⁿ⁾+ . . . +a₂·p⁽²⁾+a₁·p⁽¹⁾+a₀·p=bₘ·x^{(m)}+ . . . +b₂·x⁽²⁾+b₁·x⁽¹⁾+b₀·x

with p as the pressure of the working gas 32, x as the position of the piston 14 along the duct path K relative to its starting position, (n) as the nth derivative with respect to time, (m) as the mth derivative with respect to time, and with aᵢ and bⱼ as coefficients on the left or the right side respectively of the differential equations. Through value-based determination of the coefficients aᵢ and bⱼ, the pressure curves 50 to 56 can likewise be characterized and compared with assigned calibration values. In this sense, the coefficients aᵢ and bⱼ also constitute characteristic variables and their value-based determination the associated quantitative values in the sense of the present application. The value-based determination of the coefficients can take place sufficiently accurately, analytically and/or numerically, with the help of the ascertained curves, using average computing powers available today as can readily be present in control devices 24.

FIG. 4 depicts the pressure courses as in FIG. 3, but obtained with a pipette tip 26 provided in its accommodating space 28 with a filter 38.

Whereas in the case of pipette tips 26 without a filter 38, the assigning of a coupled pipette tip 26 to a pipette tip class can be performed either by means of the slow first embodiment of the method presented here in accordance with FIG. 2 or by means of the quick second embodiment of the method in accordance with FIG. 3, normally the slow first embodiment fails with filter-equipped pipette tips 26.

In FIG. 4, as previously in FIG. 3, the pressure curve of a pipette tip with a nominal pipetting volume of 10 μl is depicted by a solid line and labelled 60 in order to differentiate it. The pressure curve of a pipette tip with a nominal pipetting volume of 50 μl is depicted in FIG. 4 by a dashed line and labelled 62. The pressure curve of a pipette tip with a nominal pipetting volume of 300 μl is depicted in FIG. 4 by a dotted-dashed line and labelled 64. The pressure curve of a pipette tip with a nominal pipetting volume of 1000 μl is depicted in FIG. 4 by a dotted line and labelled 66.

Due to the filters 38 present in the accommodating space 28, the measurement volumes 40 of the different pipette tips 26 differ from one another less strongly than in the preceding example of filter-free pipette tips 26.

Nevertheless, FIG. 4 shows that by utilizing the aforementioned criteria, such as amplitudes of the first, second, and/or third half-oscillation or indeed a higher-ranking half-oscillation and/or by considering the periods of the first half-oscillation and/or of the second half-oscillation etc, the different pipette tips are sufficiently clearly differentiable from one another and different pipette tips can be assigned to different pipette tip classes. What was said above regarding the coefficients of the system behavior of the pipetting device 10 with a coupled pipette tip 26 as a Helmholtz resonator, applies likewise to the use of filter-equipped pipette tips. These too, are assignable unambiguously to a pipette tip class by comparing the coefficients determined in a value-based manner of the general differential equations with previously determined calibration values.

As transpires from FIGS. 3 and 4, a pressure oscillation of the working gas 32 in the measurement volume 40 induced by a pressure pulse decays after 10 ms at the latest, such that after more than 10 ms no further sufficiently individualizing information can be derived from the obtained pressure courses. Together with the oscillation excitation, the second embodiment of the present method depicted in FIGS. 3 and 4 lasts no longer than 14 ms. Beyond the examples depicted in FIGS. 3 and 4, the second embodiment can also last longer than only 14 ms, but normally no longer than 30 or 40 ms.

In the way described above, it is possible before using a pipette tip 26 just coupled to examine quickly and reliably whether the coupled pipette tip 26 is the correct pipette tip 26 for the pipetting task to be subsequently carried out with it or not. Pipetting errors up to the point of damaging the pipetting device 10 are thereby avoided.

By means of an output device 41, the control device 24 can output to operating personnel the pipette tip class thus ascertained which was assigned to the pipette tip 26.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A method for assigning a pipette tip to a particular class of pipette tips out of a plurality of different pipette tip classes, where the pipette tip classes differ with regard to a nominal pipetting volume or nominal pipetting volume range of the pipette tips assigned to the respective pipette tip classes and/or with regard to a shape of the pipette tips assigned to the respective pipette tip classes or a shape range of the pipette tips assigned to the respective pipette tip classes, the method comprising the following steps:
Coupling the pipette tip to a gas displacement device in such a way that a device-side volume formed in the gas displacement device and a tip-side volume formed by the pipette tip communicate with one another, thereby forming a measurement volume comprising the communicating volumes: device-side volume and tip-side volume,
Operating the gas displacement device and thereby changing a gas pressure in the measurement volume,
Acquiring the gas pressure in the measurement volume over an entire acquisition period,
Ascertaining at least one quantitative value of at least one characteristic variable characterizing the acquired gas pressure,
Comparing the at least one ascertained quantitative value with at least one predetermined calibration value, and
Depending on the comparison result: Assigning the pipette tip to a pipette tip class and outputting a class assigning information which represents the assigned pipette tip class.

17. The method according to claim 16, wherein operating the gas displacement device comprises displacing a piston in a cylinder along a cylinder axis.

18. The method according to claim 17, wherein operating the gas displacement device comprises displacing a piston in a first direction and subsequently in a direction opposite to the first direction.

19. The method according to claim 16, wherein the ascertaining of at least one quantitative value is based on gas pressure values which are or were acquired during the operation of the gas displacement device, where the operation effects the acquired gas pressure values.

20. The method according to claim 19, wherein operating the gas displacement device comprises displacing a piston in a cylinder along a cylinder axis, the operation of the gas displacement device comprises a displacement of the piston at a constant piston velocity for a constant displacement duration, that the acquisition of a gas pressure in the measurement volume takes place during the constant displacement duration, and that the ascertaining of at least one quantitative value is based on gas pressure values acquired during the constant displacement duration.

21. The method according to claim 16, wherein the ascertaining of at least one quantitative value is based on gas pressure values which are or were acquired temporally after the operation of the gas displacement device which effects the acquired gas pressure values.

22. The method according to claim 21, wherein the operation which effects the acquired gas pressure values comprises the production of a gas pressure surge in the measurement volume.

23. The method according to claim 22, wherein operating the gas displacement device comprises displacing a piston in a first direction and subsequently in a direction opposite to the first direction, the production of a gas pressure surge in the measurement volume comprises a piston movement in two opposite directions in the cylinder with a stroke magnitude per direction of at least 0.5 mm each with a total movement duration of no more than 12 ms.

24. The method according to claim 21, wherein the acquisition duration comprises at least the time interval from the beginning of a gas pressure change until the first return to the initial value at the beginning of the gas pressure change.

25. The method according to claim 24, wherein the acquisition duration comprises at least twice the time interval from the beginning of a gas pressure change until the first return to the initial value at the beginning of the gas pressure change.

26. The method according to claim 24, wherein the acquisition duration comprises at least three times the time interval from the beginning of a gas pressure change until the first return to the initial value at the beginning of the gas pressure change.

27. The method according to claim 21, wherein the acquisition duration comprises no more than ten times the time interval from the beginning of a gas pressure change until the first return to the initial value at the beginning of the gas pressure change.

28. The method according to claim 21, wherein the acquisition duration comprises no more than six times the time interval from the beginning of a gas pressure change until the first return to the initial value at the beginning of the gas pressure change.

29. The method according to claim 16, wherein the characteristic variable is a mean of the acquired gas pressure.

30. The method according to claim 16, wherein the characteristic variable comprises at least one variable which characterizes a temporally transient course of the acquired gas pressure.

31. A pipetting device, comprising a pipetting duct with a coupling formation which is configured for detachable coupling of a pipette tip, where the pipetting device comprises:
A pipetting duct filled with working gas, which penetrates through the coupling formation,
A gas displacement device which is in a hydromechanically communicating operative connection with the pipetting duct and is configured to displace working gas in the pipetting duct,
A pressure sensor which is arranged and configured to acquire and output a pressure of the working gas,
A control device for controlling the operation of the gas displacement device and of the pressure sensor,
A data storage device comprising at least one storage medium for storing data output by the pressure sensor which represent at least one pressure value of the working gas, where in the data storage device there are stored data which represent at least one calibration value for a comparison with at least one quantitative value of at least one characteristic variable which characterizes the acquired working gas pressure,
wherein the pipetting device is configured for implementing the method according to claim 16.

32. The pipetting device according to claim 31, wherein the gas displacement device comprises a cylinder whose cylindrical cavity at least contributes to the formation of the pipetting duct, where in the cylinder there is accommodated in a displaceable manner a pipetting piston along a cylinder axis which defines an axial direction and a radial direction orthogonal to the latter as a working gas displacement component.

33. The pipetting device according to claim 32, wherein the pipetting piston exhibits at least one permanent magnet and the cylinder exhibits current-carrying conductor coils at least in an axial drive section radially outside the pipetting duct, where the current-carrying conductor coils form a stator and the pipetting piston a rotor of an electromagnetic linear motor, where the control device is configured for energizing the conductor coils with current.
